(19) United States
(12) Patent Application Publication
(10) Pub. No.: US 2016/0279878 A1
(43) Pub. Date: Sep. 29, 2016

(54) RAPID SYNTHETIC MATERIAL PROTOTYPING PROCESS

(71) Applicant: John AMBIELLI, Cherryville, PA (US)

(72) Inventor: John AMBIELLI, Cherryville, PA (US)

(21) Appl. No.: 14/671,472

(22) Filed: Mar. 27, 2015

(51) Int. Cl. B29C 67/00

(52) U.S. Cl. CPC B29C 67/0088; B29C 67/0055; B33Y 10/00

(57) ABSTRACT

In a method of fully-integrated rapid synthetic material prototyping, a material for prototyping is selected based on pre-existing criteria. A matching composition of elements or compounds of the material is selected using at least one of materials modeling software, estimated best-choice methods, and personal experience. A predetermined amount for each element or compound of the matching composition is determined to form at least one casting, the size of the casting being determined in advance. The predetermined amounts of the matching composition are mixed. The predetermined amounts of the matching composition are melted or processed to form the casting. The casting is manufactured and processed into at least one sample. Final material properties of the at least one sample are measured. The final material properties of the at least one sample are compared to the pre-existing criteria.

### BACKGROUND

Many industries and individuals engage in the processing of materials, such as metal processing (casting, metal forming, forging, plate-forming, pipe forming, and additive manufacturing), ceramic processing (casting, sintering, pressing, additive manufacturing), glass processing (casting, pressing, additive manufacturing), polymer processing (blending, casting, pressing, additive manufacturing) and composite processing (mixing, casting, pressing, additive manufacturing). Individuals in these industries must make choices about the starting composition, or weight percentage of each element (or compound), for the particular alloy or grade (if a metal), or the particular type of ceramic, polymer, glass, or composite. Carefully choosing the best composition and subsequent processing will allow companies to produce products with certain specific properties, for example mechanical properties, service properties, and corrosion-resistance properties.

If an improper composition is selected, it will be difficult to achieve specific properties in subsequent processing steps. Alternatively, if a well-chosen composition is used, subsequent processing steps will make achieving specific properties much easier. However, it is difficult to know initially what properties and characteristics a selected composition will have after it has been fully processed because measurable properties depend on both the starting composition and the processing of that starting composition, such as casting, forging, pressing, sintering, and heat treatment.

Companies have struggled with how to select a starting composition that will allow for the optimum properties and characteristics without requiring an enormous investment of time and resources. Producing and analyzing small batches of material will not give enough realistic, real-world data to determine the alloys/mixture's properties when produced on a larger scale. Experimenting with large batches of material is too expensive and resource-intensive to be acceptable, especially given the number of different minor variations of composition that a company may need to test before finding an ideal composition for its needs.

Thus there has been a long-felt need and broad interest in the materials processing industry for a way to rapidly prototype and test various materials that both provides real-world properties of these materials and minimizes expense and resource investment.

To achieve this goal of designing a material that exhibits optimal specific properties, one needs to employ an integrated approach that involves first choosing a specific composition. The approach may then be followed with a specific recipe for processing the composition, such as thermo-mechanical processing (TMP), which includes casting, forging/forming, and heat treating. The approach may proceed to measuring specific properties of that processed composition.

### SUMMARY

Provided herein is a process for investigating materials to be used in a variety of products and components. The process provides a very economical, very rapid means of investigating and testing potential compositions. The process uses a “Check-Make” approach to materials design: the user of the process first checks to see if a given composition and TMP with attendant measured properties is in the database. If it is not, the user can set up to make the desired composition and TMP and set up to measure specific properties of that customized batch of material.

First, a user of this process decides which major material group is of interest (metals, ceramics, glasses, polymers or composites). Next, the user searches the database to see if a specific material composition, combined with a specific thermo-mechanical processing sequence, exists with measured mechanical, physical, service and corrosion properties. If it does not exist in the database, the user can launch the Rapid Material Prototype To Optimize Results (RaMatProTOR), a material prototyping software discussed below. Using the RaMatProTOR software, the user custom chooses, with or without the aid of materials modeling tools, a desired composition. Once a desirable composition is selected, the amount of each element (or compound) of the composition is determined and mixed. Depending on the material group, subsequent processing steps are parameterized. For example, for metals, at least one ingot of the matching composition is melted. Once melted, the ingot is manufactured and processed (thermo-mechanical processing) into at least one sample. The final material properties of the sample(s) are then measured. The final material properties are compared to the modeled properties (if a modeling step was initially employed). The composition of the selected material is then modified based on the final material properties, and the process is repeated with the modified composition until a composition (plus subsequent processing steps) that fulfills the needs of the company or individual is found. The RaMatProTOR cycle is very quick, on the order of days or 2-3 weeks at most, per iteration.

### BRIEF DESCRIPTION OF THE DRAWINGS

FIG. 1 shows an example of a flow diagram of the process of an embodiment (the ‘M6’ Process).

FIG. 2 shows an example of the “RaMatProTOR” software algorithm, which employs a “check-make” approach to materials prototyping.

FIG. 3A shows an example of the “CompoMaestro” tool, which may be part of the “RaMatProTOR” software package.

FIG. 3B shows another example of the “CompoMaestro” tool, which may be part of the “RaMatProTOR” software package.

FIG. 4 shows the CompoMaestro's setting and display page.

FIG. 5 shows a manufacturing diagram of part of the process of an embodiment (for a metal alloy).

FIG. 6 shows a diagram of a metal alloy forging example of part of the process of an embodiment.

FIG. 7 shows the nominal chemistry for SAE 4330.

FIG. 8 shows an example of a chemistry composition of a matching composition for an example of the process of an embodiment.

FIG. 9 shows a table of an example of the starting size range for each material to be treated with the RaMatProTOR ‘M6’ process.

### DETAILED DESCRIPTION OF EMBODIMENTS

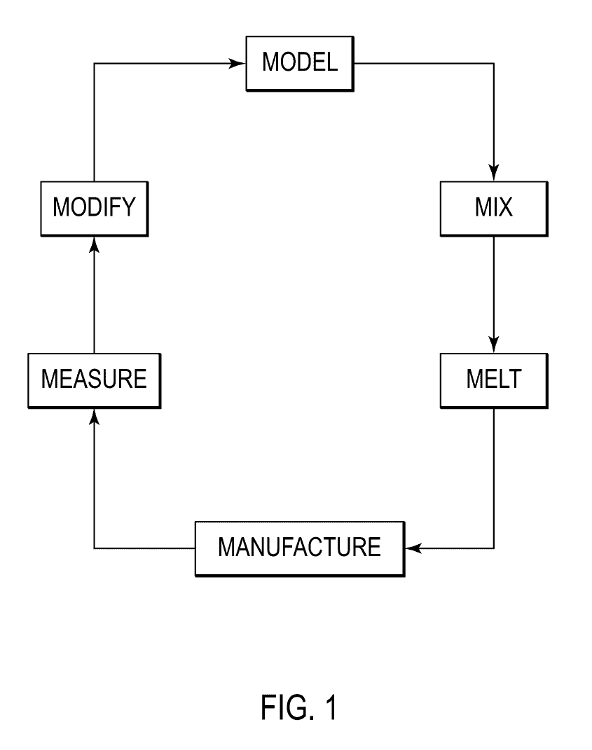

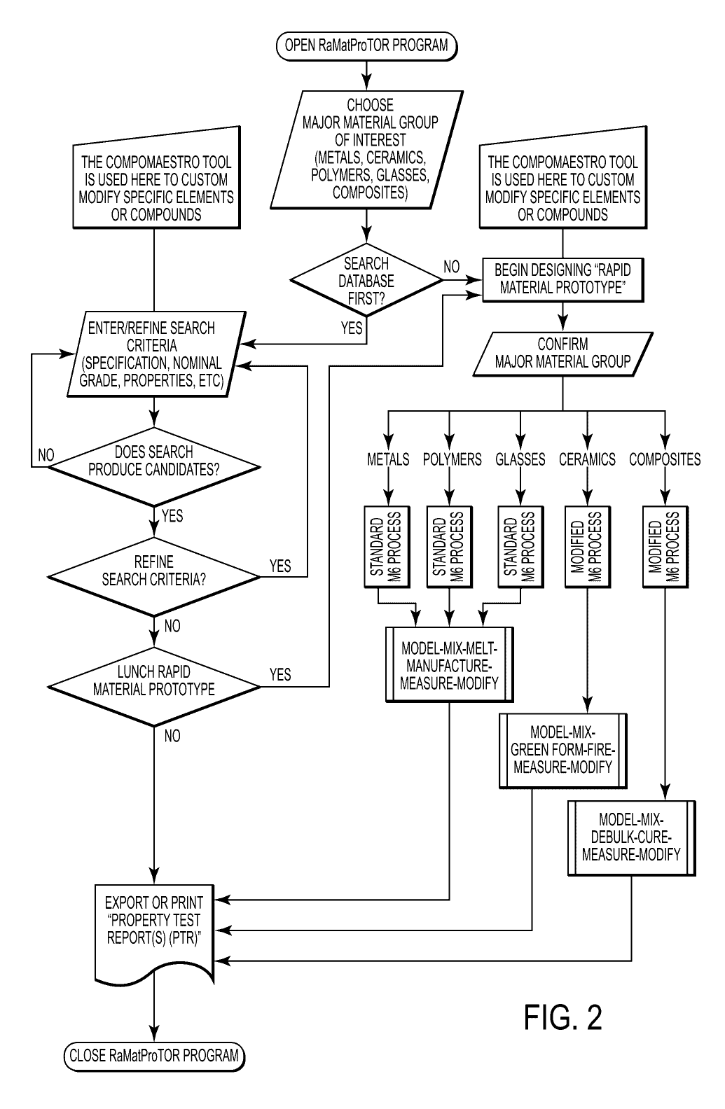

FIG. 1 shows an overall flow diagram of an embodiment of the rapid material prototyping process, the ‘M6’ Process. The ‘M6’ Process is a portion of the RaMatProTOR software algorithm shown in detail in the flowchart of FIG. 2. As explained in detail below, the ‘M6’ Process can include, for example, modeling, mixing, melting or processing, manufacturing and processing, measuring, and modifying.

Step 1: Model

First, at least one matching composition of the desired material group (metals, ceramics, glasses, polymers or composites) is selected. For this first step, modeling software may be used. If modeling software is used, any available materials modeling or simulation software package can be used (e.g. ITA Ltd's QTSteel, Thermo-Calc Software's Thermo-Calc and DICTRA, Sente Software's JMatPro, and Materials Design's MedeA). A user may select compositions based on the resulting mechanical, corrosion, and service properties of the material's composition that are provided by the modeling software. Because many of the available materials properties modeling software packages focus on specific materials, specific properties, or specific processes, using more than one software package for this determination may be beneficial. Thus, in this first step of the ‘M6’ Process, such modeling software may be used in conjunction with the RaMatProTOR software algorithm shown in FIG. 2.

A user may also select a matching composition based on known properties of the composition without use of modeling software. A user may rely on a variety of different selection methods, such as personal experience in the field, to choose a desired composition. Multiple attractive compositions may also be selected at one time to speed up the process. Accordingly, in this first step of the ‘M6’ Process, it is also acceptable to forgo the use of modeling software and rely on other selection methods for the matching composition.

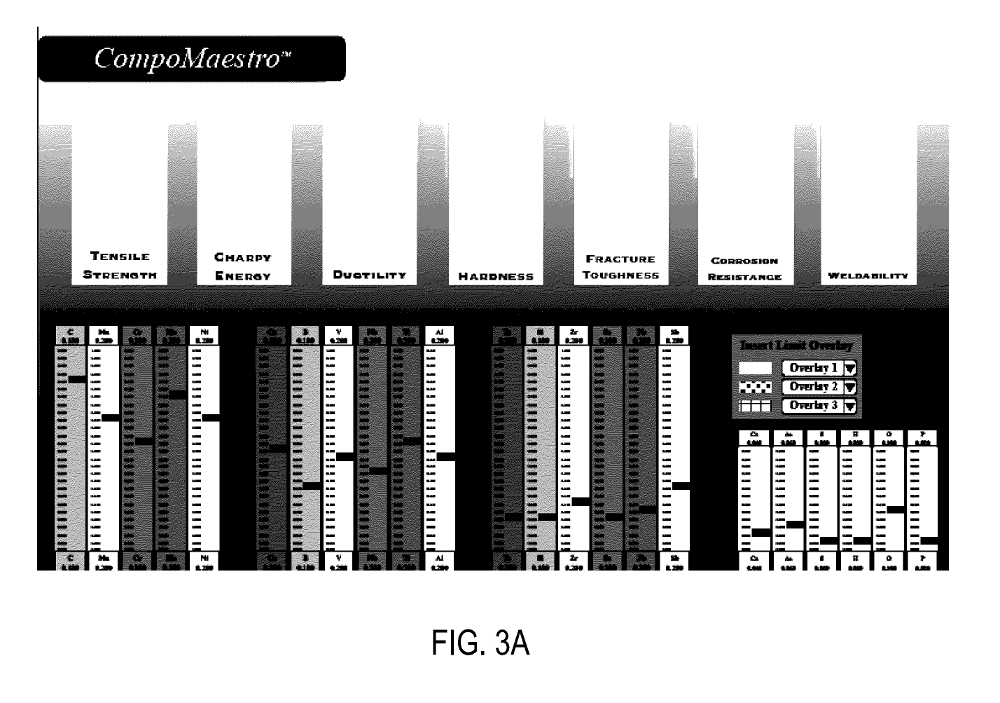

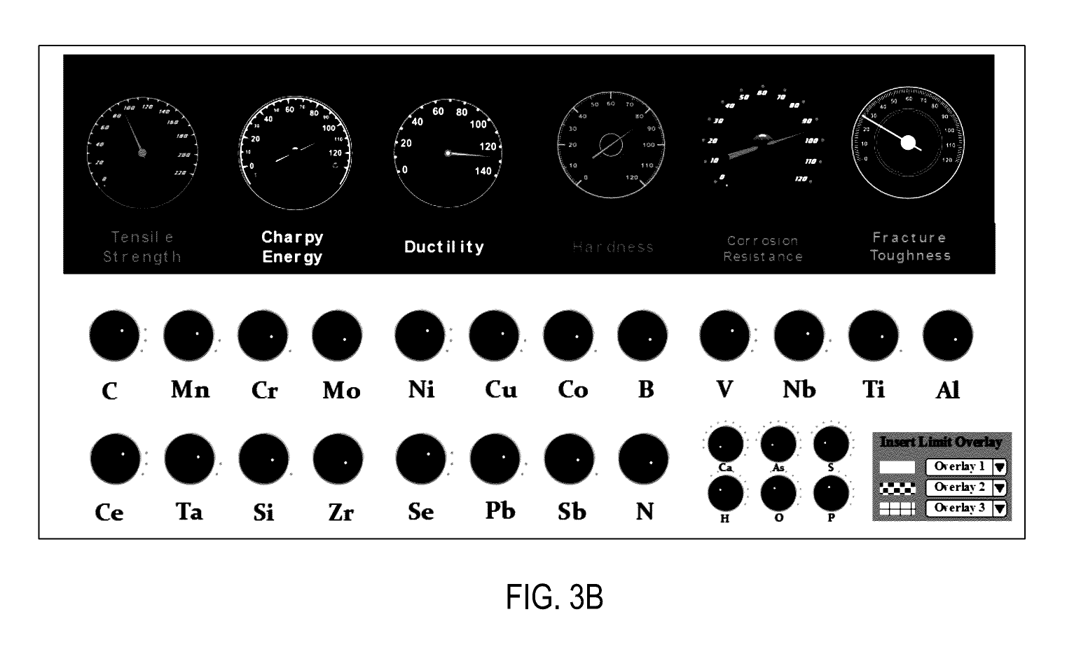

Whether or not the user uses modeling software in conjunction with the RaMatProTOR software, the RaMatProTOR software includes the CompoMaestro tool which allows the user to custom modify specific elements or compounds of the matching composition. FIGS. 3A, 3B and 4 show examples of possible formats which the CompoMaestro tool can have. FIGS. 3A and 3B are snapshots of the main screen of the CompoMaestro tool's graphical user interface (GUI). In the example of the main screen in FIG. 3A, the user has chosen the “Sliders” work environment. The “Sliders” work environment provides slidable bars for the specific properties of the matching composition which the user can slide up and down to modify the matching composition. In FIG. 3A, the user is modifying the “Basic Carbon Steel Set” and the “Major Steel Alloying Elements” chosen from the screen in FIG. 4. FIG. 3B provides one possible alternative format for the main screen in which, in place of the slidable bars, there are provided knobs which the user may operate to modify the matching composition. FIG. 4 shows further options for the user in selecting the matching composition. Once the major material group is chosen (in FIG. 4, the user has chosen “Metals”), the user can select various options and settings for the CompoMaestro tool, including but not limited to units of measurement, numbering systems, properties, work environment, data search format, and color themes. It should be noted that these examples of the CompoMaestro tool are merely examples and the CompoMaestro tool and its GUI are not limited to these detailed embodiments.

Step 2: Mix

In the second step of the ‘M6’ Process, when a desirable composition is identified, the required amounts of each element or compound of the matching composition are determined to form at least one ingot or casting. The ingots/castings are measured by weight percentages. The amounts of each element or compound are mixed together at the outset. The size of the ingot can be determined when determining amounts of each element of the candidate composition.

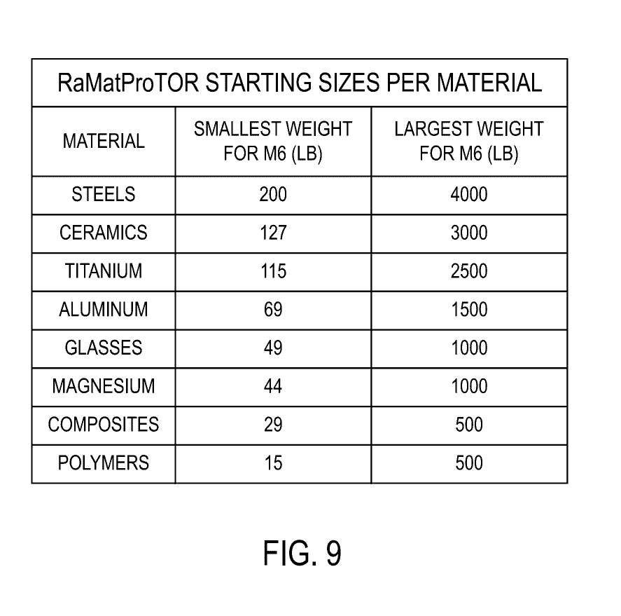

The size of the ingot/casting can vary, but it will ideally be between 200 lbs. and 4000 lbs. for metals and by a density-normalized formula for other materials such as ceramics, polymers, glasses and composites as seen in FIG. 9. For instance, a casting for steel may be approximately in the range of 200 lbs. to 4000 lbs. (i.e., 500 lbs., 1000 lbs. 1500 lbs., 2000 lbs., 2500 lbs., 3000 lbs., 3500 lbs., etc.), while a casting for ceramic may be approximately in the range of 127 lbs. to 3000 lbs. (i.e., 500 lbs., 1000 lbs. 1500 lbs., 2000 lbs., 2500 lbs., etc.). Furthermore, a casting for titanium may be approximately in the range of 115 lbs. to 2500 lbs. (i.e., 500 lbs., 1000 lbs. 1500 lbs., 2000 lbs., etc.), while a casting for aluminum may be approximately in the range of 69 lbs. to 1500 lbs. (i.e., 100 lbs., 500 lbs., 1000 lbs., etc.). A casting for glass may be approximately in the range of 49 lbs. to 1000 lbs. (i.e., 100 lbs., 250 lbs., 500 lbs. 750 lbs., etc.), while a casting for magnesium may be approximately in the range of 44 lbs. to 1000 lbs. (i.e., 100 lbs., 250 lbs., 500 lbs. 750 lbs., etc.). A casting for a composite may be approximately in the range of 29 lbs. to 500 lbs. (i.e., 50 lbs., 100 lbs. 200 lbs., 300 lbs., 400 lbs., etc.), while a casting for polymer may be approximately in the range of 15 lbs. to 500 lbs. (i.e., 50 lbs., 100 lbs. 200 lbs., 300 lbs., 400 lbs., etc.). These size ranges are small enough to be economical for the purposes of material design and development. At the same time, these size ranges are large enough to produce meaningful sample sizes for measuring material properties, such as mechanical, corrosion, and service properties, and therefore give confidence regarding the tested properties. A producer will in turn be able to scale to commercial/industrial size ingots/castings with confidence that the measured properties will not be affected by the increase in size.

The process can be used with pure virgin elements/compounds, recycled material, or both as starting materials. If recycled materials are used, they can also be used as a starting point to which other elements/compounds can be added.

Step 3: Melt or Process

Next, in the third step of the ‘M6’ Process, one or more mixes/batches of the desired composition are melted (if metals, polymers or glasses are the material group). The mix/batch can be melted using a melting furnace or oven or using laser energy. A variety of melting furnaces can be used, for example induction, electric arc, vacuum induction, gas-fired or electric crucible, hearth, or cupola. For ceramics and composites, a slightly modified process is used. For ceramics, a green form is made and then it is fired or sintered (processed). For composites, this step includes debulking and then curing (processing).

Once the candidate composition is sufficiently and completely melted (or green formed as in ceramics; or debulked as in composites), it can be poured into either a refining ladle or directly into a mold. The mold can be made of various materials such as sand, ceramic, or metal. The ingot/casting of the candidate composition can be left to solidify and cool. Multiple ingots/castings can also be made at one time.

Step 4: Manufacture and Process

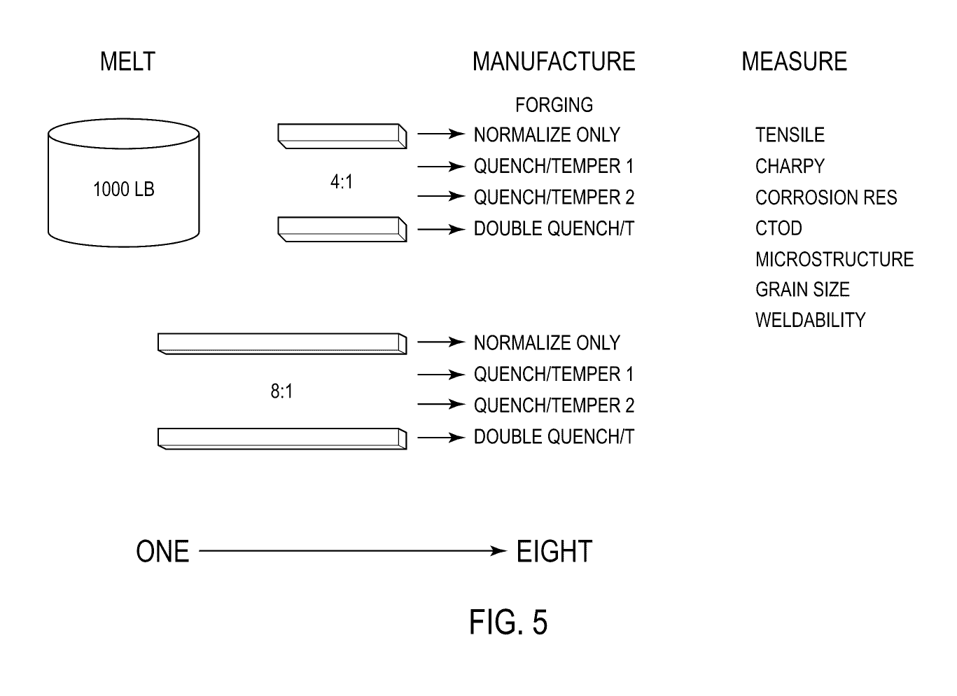

Then, in the fourth step of the ‘M6’ Process, the ingot/casting is manufactured and processed into at least one processed sample. FIG. 6 provides examples of possible paths of manufacturing a metals example.

The types of manufacturing and processing used can be determined by the company or user. The types used will depend upon the material properties that are being investigated. For example, if the properties of a metal casting are to be explored, the ingot/casting may be directly measured. The ingot/casting can also be put through various heat treatments, again depending on the requirements. If properties of a wrought metal product are to be investigated, thermo-mechanical processes (such as forging and heat treatment) can be applied to the ingot/casting. Many variations of manufacturing/working/processing steps are available to ceramics, polymers, glasses and composites.

Additionally, anywhere from one to many dozens of individually-processed samples, all with the exact same chemical composition, can be produced from one ingot/casting/batch.

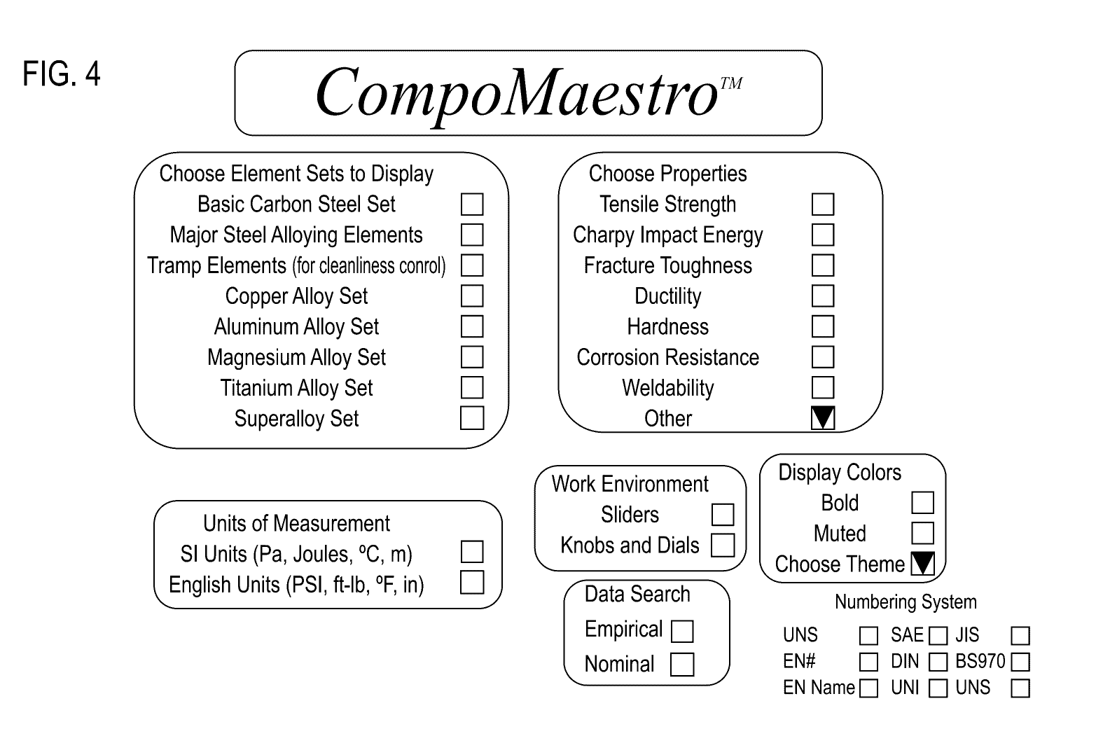

A variety of different thermo-mechanical processing (TMP) steps may be applied. For example, a casting engineer's TMP requirements could involve: (1) once mixed and melted, an ingot is allowed to cool to room temperature; (2) the ingot could then be cut with a saw into, for example, 4 sample pieces; and (3) each sample piece would then go through a variety of different heat treatments, for example: (a) normalize only (N); (b) Austenitize-water-quench-temper at a specific temperature (AWQT1); (c) Austenitize-water-quench-austenitize-water-quench-temper (AWQAWQT1), also known as double-austenitizing; and/or (d) Austenitize-water-quench-temper at a different temperature (AWQT2). FIG. 5 provides a forging example for the steps of melting, manufacturing and processing, and measuring.

A set of forming/forging TMP steps may involve, for example for a metal alloy: (1) once the ingot is cooled to room temperature, it is formed (or wrought) by at least two reduction ratios, for example 4:1 and 8:1, and forming can include forging, extrusion, or plate rolling; (2) the bar/tube/plate that is formed can be cut into 4 smaller bars/tubes/plates (2 being of 4:1 ratio and 2 being of 8:1 ratio, as shown in FIG. 5); (3) the 2 sets of two bars go through 4 common heat treatments; and (4) 8 different chemistry/TMP combinations would be produced from the ingot. A reduction ratio can be considered to be the amount of cross-sectional reduction taking place during drawing out of a sample. The original cross-section of a sample divided by the final cross-section of the sample can be the reduction ratio.

Additionally, additive manufacturing (AM) thermo-mechanical processing may be used, which would be similar to a casting engineer's TMP. Additive manufacturing is a form of casting, but the “casting” happens while the component is being made. It starts with a certain chemical composition—in the form of a powder mix—being sprayed layer-by-layer to make the shape of the component. Once made, the material can be heat treated like a casting.

For each major material category (metals, ceramics, polymers, glasses and ceramics), the required RaMatProTOR steps will vary accordingly. FIG. 2. provides examples of the varying steps for the ‘M6’ Process in the RaMatProTOR algorithm. For instance, the ‘M6’ Process for metals, polymers, and glasses may include modeling, mixing, melting, manufacturing, measuring, and modifying. For ceramics, the ‘M6’ Process may include, for example, modeling, mixing, green forming (processing), firing (processing), measuring, and modifying. For composites, the ‘M6’ Process may include, for example, modeling, mixing, debulking (processing), curing (processing), measuring, and modifying.

Step 5: Measure

Next, in the fifth step of the ‘M6’ Process, a variety of final material properties of the sample(s) can be measured when the chosen manufacturing and processing steps have been completed.

These properties may include, but are not limited to: mechanical properties (strength—tensile, compressive, shear, torsional, fatigue; hardness; ductility; modulus of elasticity), service properties (fracture toughness—both dynamic and static; high temperature mechanical properties; cryogenic mechanical properties, etc.), and corrosion resistance properties (general attack; localized—pitting, crevice, filiform; galvanic; environmental cracking—stress corrosion cracking, corrosion fatigue, hydrogen induced cracking; high temperature corrosion). A large variety of ASTM tests for mechanical and service property measurements, as well as metallographic exams and tests, can be performed and are well-known in the materials processing and testing industry.

The results of these material property measurements give vital information about the performance of the starting composition combined with specific processing steps. These results can be entered into a database and can provide help to software developers when adjusting their modeling algorithms to reflect actual, final material properties achieved rather than idealized or small-sample-size results. The growing empirical-oriented database serves as a powerful and useful tool for future investigators.

Step 6: Modify

In the sixth step of the ‘M6’ Process, the final material properties of the processed samples are evaluated to determine if they are acceptable for the purposes of the company or user. The final material properties of the samples are compared to pre-existing criteria for the desired composition. If the final material properties do not match the pre-existing criteria and are not acceptable to the company or user, the matching composition can be modified based on the comparison to a new starting composition that will further match the desired pre-existing criteria. Additionally or alternatively, the manufacturing and processing steps can be changed to achieve the desired pre-existing criteria of the final composition. The process can then be performed again on the newly-modified starting composition and/or using the new manufacturing and processing steps.

The company or user can evaluate, based on the final measured properties, whether or not the modeling of the alloy compositions accurately predicted the properties that the matching composition, combined with the processing, exhibited in practice. If the modeling did not accurately predict the final material properties that were actually measured, this variance can be inputted into modeling software to align prediction with reality.

If the final material properties of the starting composition are acceptable for the purposes of the user, this composition can then be used as the final composition for the sought-after material. The material can be scaled and used in real-world production, and the company or user can feel confident that the material properties will not alter when the material is actually used.

Example of an Embodiment of the Process:

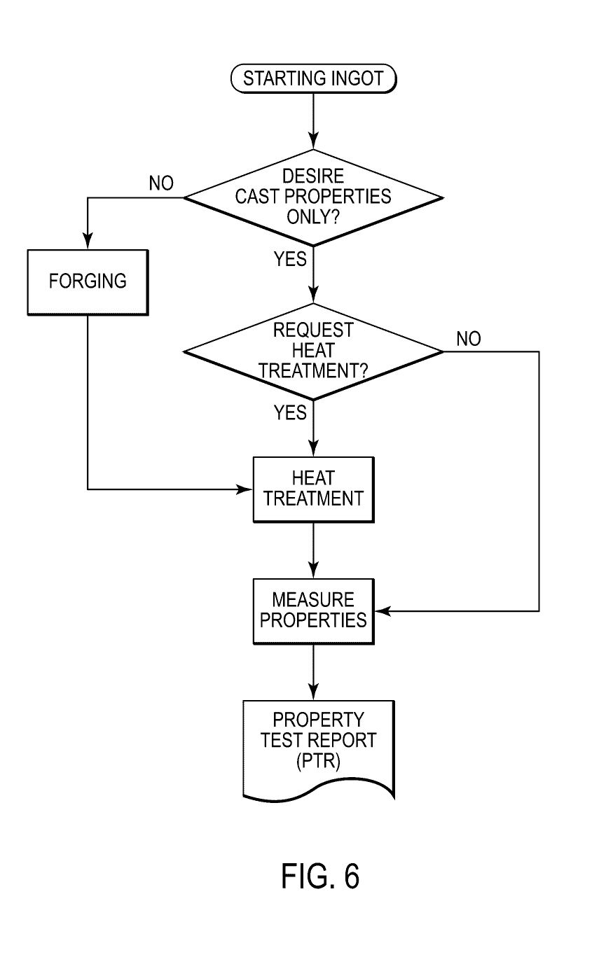

An example will be provided herein for illustrative purposes. A user may wish to choose a particular steel for a new pipeline. The user has pre-existing criteria in the form of a set of operational and service requirements (for example, required yield strength, toughness requirements, corrosion-resistance requirements, weldability, etc.) that the material needs to meet. The user would like to investigate one material in particular, SAE 4330. FIG. 7 shows the nominal chemistry (and includes the “steps” for the designer's options) of the material SAE 4330.

The user can use the CompoMaestro tool to adjust the controlled and non-controlled elements in this example. For example, the user could use the “Sliders” work environment of FIG. 3A and adjust the elements by moving the slidable bars up and down.

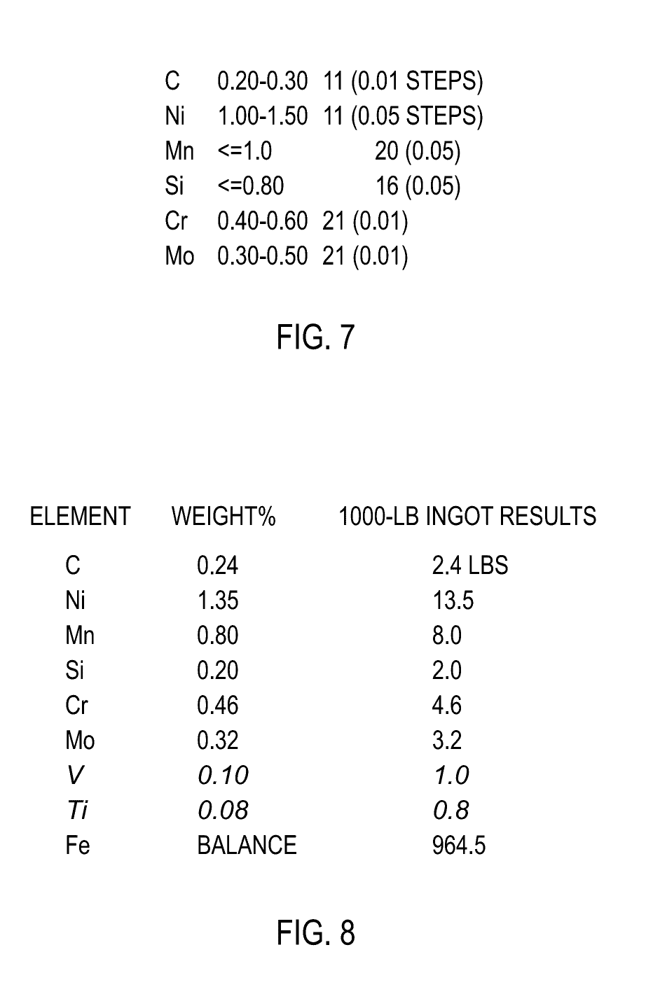

Once the desired chemistry compositions are chosen, amounts for an ingot are determined and a precise batch of the steel is mixed (by weight percentage) and melted into an ingot. FIG. 8 shows an example of a composition that will be processed (a 1000-lb. ingot). Note that the V and Ti in the final composition are added. This is often done to enhance properties. As long as extra elements are not specifically forbidden by a given standard (in this case SAE 4330), they can be included in a custom-designed variation of the nominal grade.

This ingot, with a known and fixed chemical composition, then undergoes various thermo-mechanical processing options to form multiple samples as seen in FIG. 5. Samples from the formed/heat treated bars are then removed for mechanical, service, corrosion-resistance and weldability testing. After these individual chemistry/thermo-mechanical processing samples are tested, a thorough matrix of results can be produced of the final material properties of the ingot. The results can then be compared to the pre-existing criteria (the set of operational and service requirements). If required or desired, a modified starting composition and/or modified processing steps can be newly selected, and the process can be repeated.

By using this process, the user has much more confidence in the steel that he will choose (with a very specific starting chemistry and set of thermo-mechanical processing steps) for the pipeline project. By producing and analyzing a casting/ingot of sufficient size to provide realistic, real-world data without requiring the expense and resources needed for producing large, production-sized batches, he has limited his risk, has ensured confidence in any subsequent large expenditure that may be required to produce production-sized samples of the steel, and has saved time and money for the project.

Exemplary embodiments of the present invention have been described above. It should be noted that the above exemplary embodiments are merely examples and the present invention is not limited to the detailed embodiments.

What is claimed is:

1. A method of fully-integrated rapid synthetic material prototyping, comprising the following steps:
selecting a material for prototyping based on pre-existing criteria;
selecting a matching composition of elements or compounds of the material using at least one of materials modeling software, estimated best-choice methods, and personal experience;
determining a predetermined amount for each element or compound of the matching composition to form at least one casting, the size of the casting being determined in advance;
mixing the predetermined amounts of the matching composition;
melting or processing the predetermined amounts of the matching composition to form the casting;
manufacturing and processing the casting into at least one sample;
measuring final material properties of the at least one sample; and
comparing the final material properties of the at least one sample to the pre-existing criteria.

2. The method of claim 1, wherein
if the final material properties do not match the pre-existing criteria, a modification to the matching composition is calculated, the matching composition is modified, and a new casting is made.

3. The method of claim 1, wherein
the determining of the predetermined amount includes adjusting an amount of each element or compound using a graphical user interface providing adjustment via slidable controls or knob controls.

4. The method of claim 1, wherein
the casting is between 200 lbs. and 4000 lbs. for a metal alloy, between 127 lbs. and 3000 lbs. for a ceramic, between 49 lbs. and 1000 lbs. for a glass, and between 15 lbs. and 500 lbs. for a polymer.

5. The method of claim 1, wherein
the final material properties and the pre-existing criteria include mechanical properties, service properties, and corrosion resistance properties, and
measuring the final material properties of the at least one sample includes measuring the mechanical properties, the service properties, and the corrosion resistance properties.

6. The method of claim 5, wherein
the mechanical properties are selected from the group consisting of tensile strength, compressive strength, shear strength, torsional strength, fatigue strength, hardness, ductility, and modulus of elasticity.

7. The method of claim 5, wherein
the service properties are selected from the group consisting of dynamic fracture toughness, static fracture toughness, high-temperature mechanical properties, and cryogenic mechanical properties.

8. The method of claim 5, wherein
the corrosion resistance properties are selected from the group consisting of general attack, pitting localized attack, crevice localized attack, filiform localized attack, galvanic, stress corrosion cracking, corrosion fatigue, hydrogen-induced cracking, and high-temperature corrosion.

9. The method of claim 1, wherein
measuring the final material properties of the at least one sample includes measuring a microstructure of the at least one sample.

10. The method of claim 1, wherein
the casting is manufactured and processed into a plurality of samples, and each of the plurality of samples is individually processed.

11. The method of claim 1, wherein
the at least one sample is not processed with any treatments before measuring the final material properties of the at least one sample.

12. The method of claim 1, wherein
the at least one sample is processed by thermo-mechanical processing before measuring the final material properties of the at least one sample.

13. The method of claim 1, wherein
the at least one sample is processed by a heat treatment before measuring the final material properties of the at least one sample.

14. The method of claim 13, wherein
the at least one sample is processed by forging and the heat treatment before measuring the final material properties of the at least one sample.

15. The method of claim 1, wherein
the final material properties of the at least one sample are entered into a database.

16. The method of claim 1, wherein
the casting is formed by at least one reduction ratio.

17. The method of claim 16, wherein
the casting is formed using forging, extrusion, or plate rolling.

18. The method of claim 1, wherein
at least one element or compound includes recycled material.

19. The method of claim 1, wherein
the casting is formed through additive manufacturing.

20. The method of claim 1, wherein
the matching composition is a powder mix.
